(19) United States
(12) Patent Application Publication
(10) Pub. No.: US 2026/0017341 A1
(43) Pub. Date: Jan. 15, 2026

(54) SYSTOLIC ARRAY, INFORMATION PROCESSING APPARATUS, AND METHOD FOR ARITHMETIC OPERATION

(71) Applicant: Fujitsu Limited, Kawasaki-shi (JP)

(72) Inventor: Shiho NAKAHARA, Nerima (JP)

(73) Assignee: Fujitsu Limited, Kawasaki-shi (JP)

(21) Appl. No.: 19/231,666

(22) Filed: Jun. 9, 2025

(30) Foreign Application Priority Data
Jul. 9, 2024 (JP) 2024-110538

(51) Int. Cl. G06F 17/16

(52) U.S. Cl. CPC G06F 17/16

(57) ABSTRACT

A systolic array includes a plurality of processing elements, the systolic array including a first systolic array and a second systolic array that are obtained by partitioning the systolic array, and a controller. The second systolic array is positioned downstream of the first systolic array. Each of the plurality of processing elements includes a selector that selectively outputs an output signal, and the controller switches the output signals of the plurality of processing elements from the selectors between first processing elements positioned on a last stage of the first systolic array and second processing elements, the second processing elements being processing elements of the second systolic array and processing elements of the first systolic array except for the first processing elements.

### CROSS-REFERENCE TO RELATED APPLICATION

This application is based upon and claims the benefit of priority of the prior Japanese Patent application No. 2024-110538, filed on Jul. 9, 2024, the entire contents of which are incorporated herein by reference.

### FIELD

The embodiment discussed herein relates to a systolic array, an information processing apparatus, and a method for arithmetic operation.

### BACKGROUND

A matrix product operation is the major arithmetic operation for learning (training) and inferring a DNN (Deep Neural Network) exemplified by a LLM (Large Language Model).

One of the accelerators for accelerating a matrix product operation is a two-dimensional Systolic Array (SA). Such two-dimensional SA that executes a matrix product operation is classified into three types of: output stationary, input stationary, and weight stationary.

For example, related arts are disclosed in Japanese National Publication of International Patent Application No. 2022-540548 and U.S. patent Ser. No. 11/003,619.

### SUMMARY

According to an aspect of the embodiment, a systolic array includes a plurality of processing elements, the systolic array including: a first systolic array and a second systolic array that are obtained by partitioning the systolic array, the second systolic array being positioned downstream of the first systolic array; and a controller. Each of the plurality of processing elements includes a selector that selectively outputs an output signal, and the controller switches the output signals of the plurality of processing elements from the selectors between first processing elements positioned on a last stage of the first systolic array and second processing elements, the second processing elements being processing elements of the second systolic array and processing elements of the first systolic array except for the first processing elements.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a matrix multiply-add process in a related example;

FIG. 2 is a diagram illustrating an example of partitioning a SA in calculating a small multiplier matrix in the related art;

FIG. 3 is a diagram illustrating a matrix multiply-add process when a SA is partitioned to two partitions in a vertical direction according to an embodiment;

FIG. 4 is a flow chart illustrating a process performed by a controller illustrated in FIG. 3;

FIG. 5 is a diagram illustrating a data flow in a PE except for PEs on a boundary row in the SA in the matrix multiply-add process of FIG. 3;

FIG. 6 is a diagram illustrating a data flow in a PE on the boundary row in the SA in the matrix multiply-add process of FIG. 3;

FIG. 7 is a diagram illustrating a matrix multiply-add process when a SA is partitioned to two partitions in a horizontal direction according to the embodiment;

FIG. 8 is a diagram illustrating a data flow in a PE on a boundary column in the SA in the matrix multiply-add process of FIG. 7;

FIG. 9 is a diagram illustrating a matrix multiply-add process when a SA is partitioned to three partitions in a vertical direction according to the embodiment;

FIG. 10 is a diagram illustrating a matrix multiply-add process when a SA is partitioned to three partitions in a horizontal direction according the embodiment;

FIG. 11 is a block diagram schematically illustrating an example of a hardware configuration of an information processing apparatus of the embodiment; and

FIG. 12 is a diagram illustrating comparison between the matrix multiply-add process of the embodiment and that of the related example.

### DESCRIPTION OF EMBODIMENT(S)

However, if the multiplier matrix input into a SA is smaller than the size of the SA, the arithmetic calculation performance may be degraded because the number of Processor Elements (PEs) used in the SA is reduced. The arithmetic calculation performance is expressed by the following expression.

(FLOP/s)=2×(the Number of PEs being used in SA)×(clock frequency)

In addition, in the unused PE, a multiply-add operation with 0 is performed, and the power consumed is wasted.

### <A> Related Example

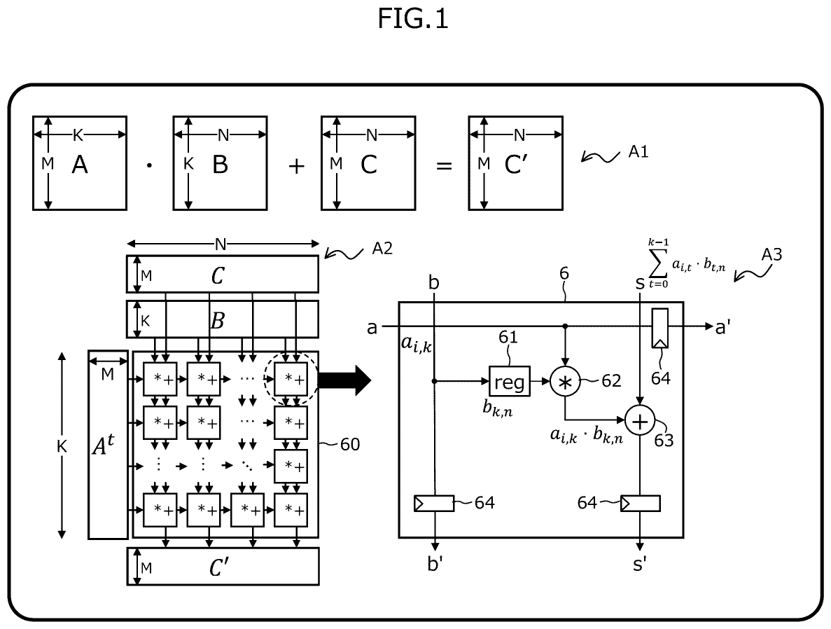

FIG. 1 is a diagram illustrating a matrix multiply-add operation process in a related example.

In an example illustrated in FIG. 1, as illustrated in the reference sign A1, an M rows and N columns (hereinafter referred to as “M×N”) matrix C is added to the product of an M×K matrix A and a K×N matrix B to obtain an M×N matrix C′.

As illustrated in the reference sign A2, into an SA 60, a matrix A^{t}(A^{t} represents a transpose of matrix A) is input from the row direction and matrices B and C are input from the column direction, and consequently a matrix C′ is output from the column direction.

A PE 6 illustrated in the reference sign A3 includes a register (reg) 61, a multiplier 62, an adder 63, and three Flip-Flops (FFs) 64.

An element of a multiplier matrix B is stored into a register 61 of each PE 6 by using a signal line b and a value of the matrix A^{t} is subsequently input into the PE 6 from the left using a signal line a. In each PE 6, the product is calculated by the multiplier 62 and the partial sum is passed to the lower (subsequent, downstream) PE 6 by an adder 63 using a matrix C from a signal line s. The three FFs 64 are provided immediately before (upstream of) the output signal lines a′, b′, and s′ and adjust the output timing of the respective output signals. Then, the matrix C′ is sequentially output from the output s′ of the lowest (most downstream) PE 6.

Here, if the multiplier matrix input into the SA 60 is smaller than the size of the SA 60, the arithmetic calculation performance may be degraded because the number of PEs used in the SA 60 is reduced. In addition, each unused PE 6 carries out a multiply-add process with 0 (zero), which wastes consumption electricity.

As a solution to the above, partitioning the SA 60 into small SAs 60 (i.e., SA #1 and SA #2) would increase the number of PEs 6 to be used so that the calculation performance is increased.

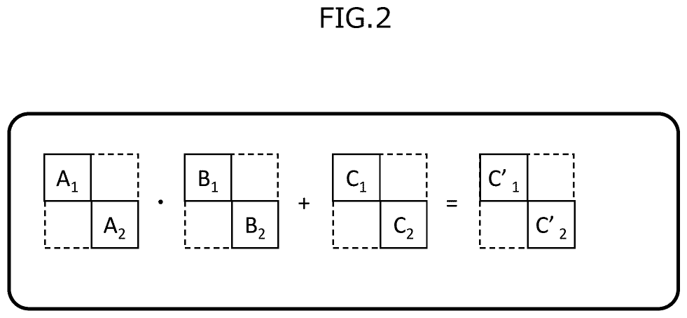

FIG. 2 is a diagram illustrating an example of partitioning a SA 60 in calculating a small multiplier matrix in the related art.

In the example illustrated in FIG. 2, two matrix calculations of the half size of the SA 60 are performed as illustrated in the following expressions.

$${A}_{1} \cdot {B}_{1} + {C}_{1} = {C}_{1}^{′}$$

$${A}_{2} \cdot {B}_{2} + {C}_{2} = {C}_{2}^{′}$$

This increases the arithmetic calculation performance from 25% to 50% as compared to a case where a single matrix calculation of the half size of the SA 60 is performed.

However, the method illustrated in FIG. 2 can be applied only to a matrix small in both the row direction and the column direction.

### <B> Embodiment

Hereinafter, an embodiment will now be described with reference to the accompanying drawings. However, the following embodiment is merely illustrative and is not intended to exclude the application of various modifications and techniques not explicitly described in the embodiment. For example, the present embodiment can be variously modified and implemented without departing from the scope thereof. Further, each of the drawings can include additional functions not illustrated therein to the elements illustrated in the drawing.

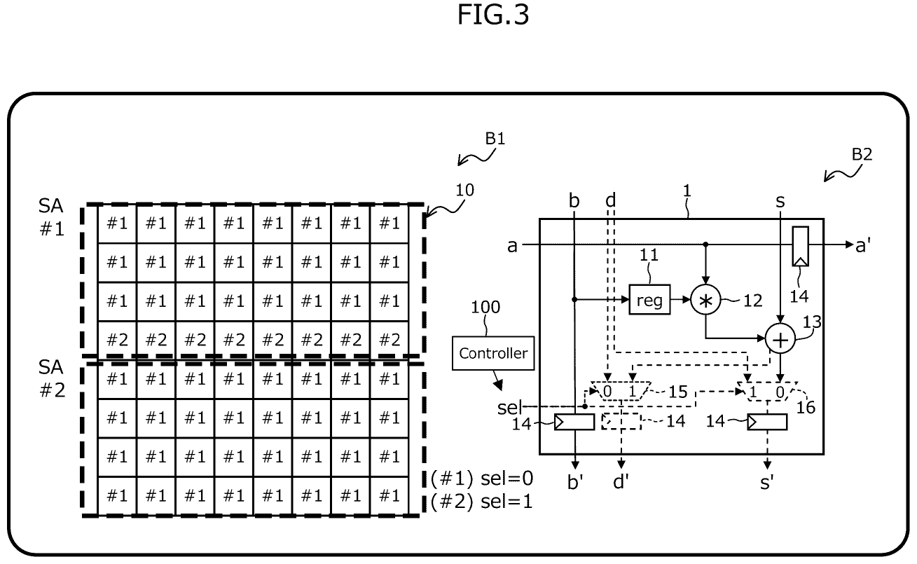

FIG. 3 is a diagram illustrating a matrix multiply-add (multiply-accumulate) process when a SA is partitioned to two partitions in a vertical direction according to an embodiment.

In the example illustrated in FIG. 3, as illustrated in the reference sign B1, a SA 10 (systolic array) is partitioned into a 4×8 SA (SA having 4 rows and 8 columns) #1 (i.e., a first systolic array) and a 4×8 SA #2 (i.e., a second systolic array).

Among the PEs 1 included in the SA #1, the PEs 1 of the first to third rows are designated to a group #1, and the PEs 1 of the fourth row, which is the boundary row with the SA #2, are designated to a group #2. On the other hand, in the SA #2, the PEs 1 of all the first to fourth rows of are designated to the group #1.

The PE 1 illustrated in the reference sign B2 includes a register (reg) 11, a multiplier 12, an adder 13, four FFs 14, and selectors 15 and 16. The elements illustrated by the dashed lines in PE 1 indicate elements added to the elements in PE 6 of the related example illustrated in FIG. 1.

The register 11 stores an element of the matrix B received from the signal line b. The multiplier 12 multiplies an element of the matrix A received from the signal line a and an element of the matrix B stored in the register 11. The adder 13 adds the result of the multiplication of the multiplier 12 and the matrix C received from the signal line s.

In response to a sel signal input from the controller 100, the selector 15 selects an input from the signal line d for inputting the matrix C into the SA #2 or the result of the addition of the adder 13, and outputs the selected input or the selected result to the signal line d′. In response to the sel signal, the selector 16 selects the input from the signal line d or the result of the addition of the adder 13, and outputs the selected input or the selected result to the signal line s′.

In other words, the controller 100 switches the output signals from the selectors 15 and 16 in the multiple PEs 1 between the PEs 1 on the last (most downstream) stage (row) of the SA #1 and the remaining PEs 1 (i.e., the PEs 1 except for the PEs 1 on the last stage (row) of the SA #1 and the PEs 1 of the SA #2). The PEs 1 on the last stage (row) of the SA #1 are examples of first processing elements. The remaining PEs 1 are examples of second processing elements.

As indicated by the reference sign B1, into the PEs 1 of the group #1, the sel signal “0” is input, and into the PEs 1 of the group #2, the sel signal “1” is input.

This means that since sel=0 is input into the selectors 15 and 16 in each PE 1 of the group #1, the selector 15 outputs the input received from the signal line d and the selector 16 outputs the result of the addition of the adder 13. In contrast, since sel=1 is input into the selectors 15 and 16 in each PE 1 of the group #2, the selector 15 outputs the result of the addition of the adder 13 and the selector 16 outputs the input received from the signal line d.

The four FFs 14 are provided immediately before (upstream of) the output signal lines a′, b′, d′, and s′, and adjust the output timing of the respective output signals.

Into the PEs 1 on the highest (most upstream) stage, the matrix C received from the signal line s to the SA #1 is input, and the matrix C received from the signal line d to the SA #2 is input. On the other hand, the PEs 1 on the lowest (most downstream) stage outputs the output of the SA #1 from the signal line d′ and outputs the output of the SA #2 from the signal line s′.

The PE 1 indicated by the reference sign B2 includes the signal lines s, s′, d, and d′. The signal line s inputs (receives) a constant matrix C1. The signal line s′ outputs the result C₁′ of an arithmetic operation. The path from the signal line s to the signal line s′ carries out a process of from receiving an input of a constant matrix C1 to outputting of the result C₁′ of an arithmetic operation. The signal line d inputs (receives) the constant matrix C₂. The signal line d′ outputs the result C₂′ of an arithmetic operation. The path from the signal line d to the signal line d′ carries out a process of from receiving an input of the constant matrix C₂ to the outputting of the result C₂′ of an arithmetic operation.

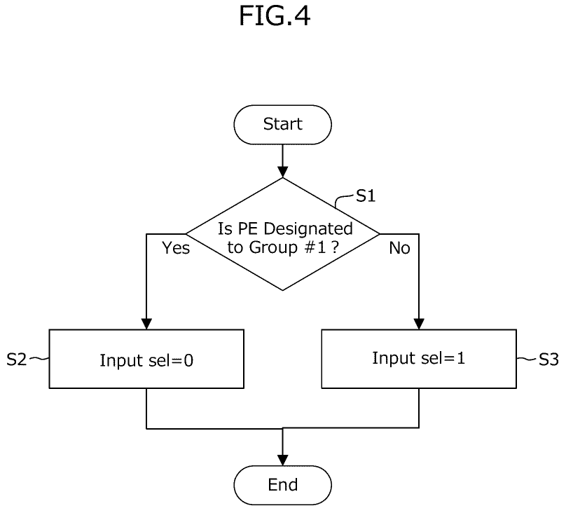

The process of the controller 100 illustrated in FIG. 3 will be now described with reference to the flow chart (Steps S1 to S3) illustrated in FIG. 4.

The controller 100 determines whether the PE 1 is designated to the group #1 (Step S1).

If the PE 1 is designated to the group #1 (see Yes route in Step S1), the controller 100 inputs sel=0 into the selectors 15 and 16 (Step S2). Then, the process ends.

On the other hand, if the PE 1 is not designated to the group #1, which means that the PE 1 is designated to the group #2 (see No route in Step S1), the controller 100 inputs sel=1 to the selectors 15 and 16 (Step S3). Then, the process ends.

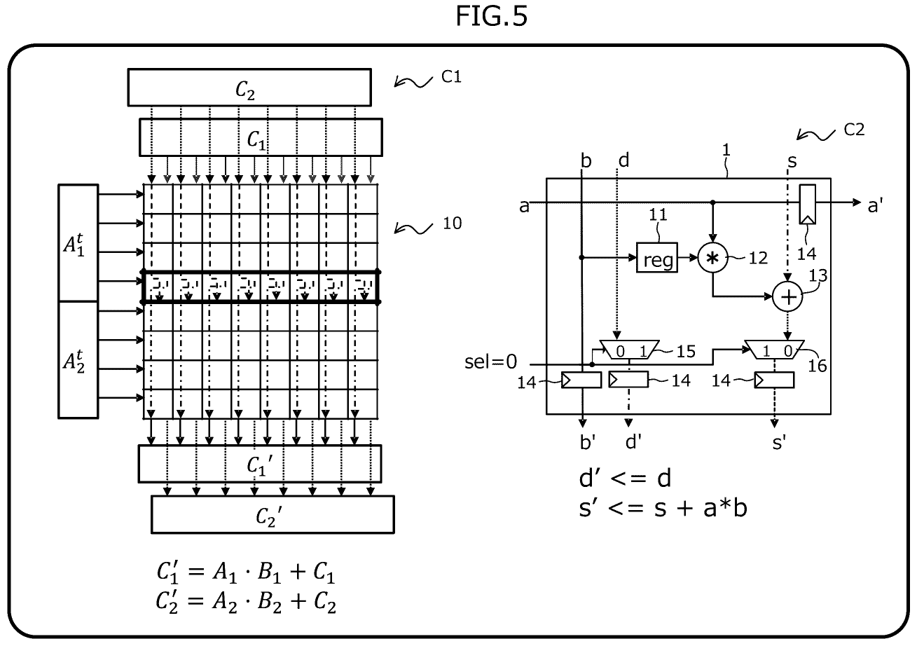

FIG. 5 is a diagram illustrating a data flow in a PE 1 except for PEs 1 on a boundary row in the SA 10 in the matrix multiply-add process of FIG. 3. In the reference sign C1 of FIG. 5, the boundary row in the SA 10 is indicated by a thick frame.

In the example illustrated in FIG. 5, two matrix calculations of the half size in the row direction of the SA 10 are performed as illustrated in the following expressions.

$${C}_{1}^{′} = {A}_{1} \cdot {B}_{1} + {C}_{1}$$

$${C}_{2}^{′} = {A}_{2} \cdot {B}_{2} + {C}_{2}$$

As illustrated in the reference sign C1, into the SA 10, a matrix A₁^{t} is input into the SA #1 from the row direction and a matrix A₂^{t} is input into the SA #2 from the row direction, and also a matrix C1 is input into the SA #1 from the column direction and a matrix C₂ is input into the SA #2 from the column direction. Furthermore, the matrix C₁′ is output from the SA #1 from the column direction, and the matrix C₂′ is output from the SA #2 from the column direction. The matrix B is input through the signal line(s) b beforehand and held in the register(s) 11.

As illustrated in the reference sign C2, since sel=0 is input into the selectors 15 and 16, the selector 15 outputs the input received from the signal line d and the selector 16 outputs the result of the addition of the adder 13.

In this case, the signal line s′ outputs “s+a*b” (s′←s+a*b), and the signal line d′ outputs “d” (d′←d).

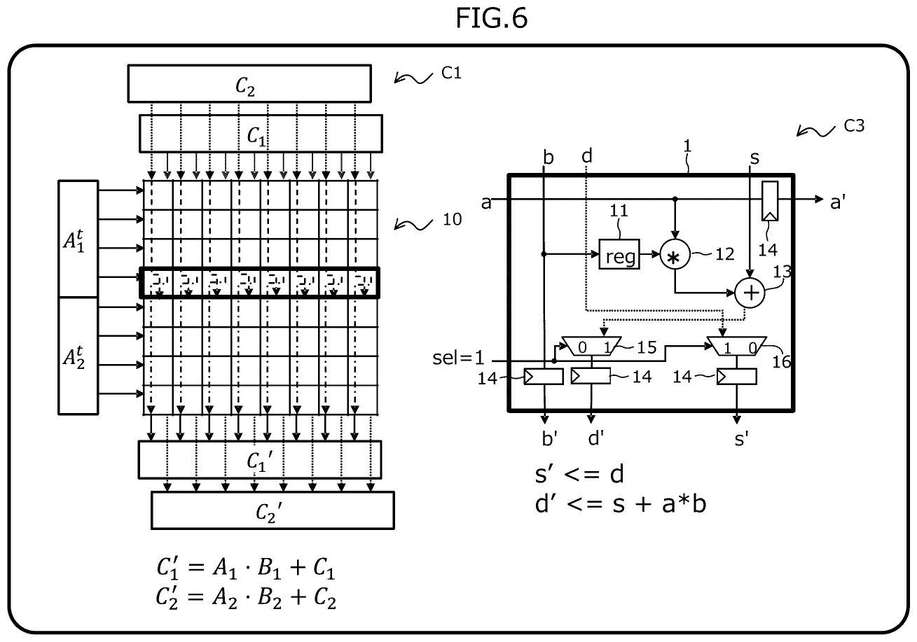

FIG. 6 is a diagram illustrating a data flow in a PE 1 on the boundary row in the SA 10 in the matrix multiply-add process of FIG. 3. The reference numeral C1 in FIG. 6 is the same as the reference numeral C1 in FIG. 5.

As illustrated in the reference sign C3, since sel=1 is input into the selectors 15 and 16, the selector 15 outputs the result of the addition of the adder 13 and the selector 16 outputs the input from the signal line d.

In this case, the signal line s′ outputs “d” (s′←d), and the signal line d′ outputs “s+a*b” (d′←s+a*b).

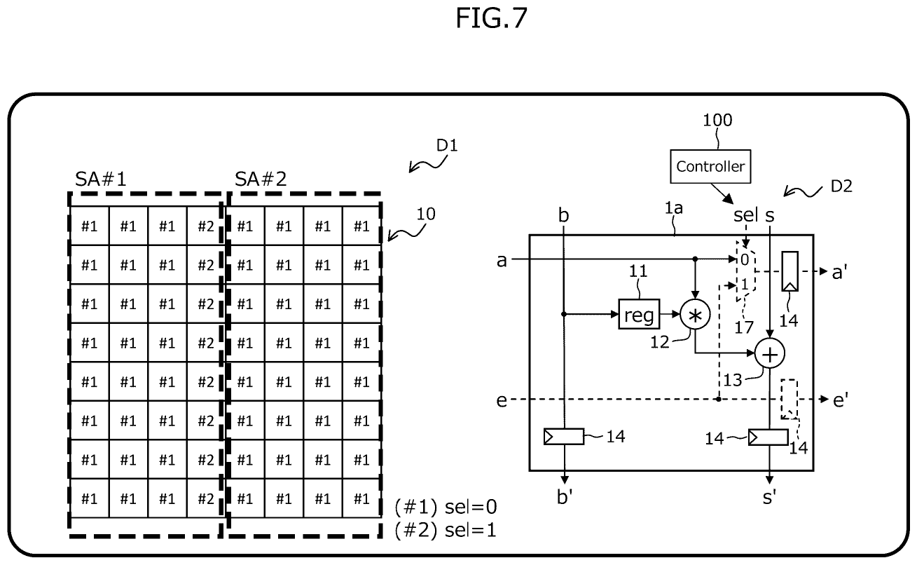

FIG. 7 is a diagram illustrating a matrix multiply-add process when a SA 10 is partitioned into two partitions in a horizontal direction according to the embodiment.

In the example illustrated in FIG. 7, as indicated by the reference sign D1, the SA 10 is partitioned into an 8×4 SA #1 and an 8×4 SA #2.

Among the PEs 1a included in the SA #1, the PEs 1 of the first to third columns are designated to a group #1, and the PEs 1a of the fourth column, which is the boundary column with the SA #2, are designated to a group #2. On the other hand, in the SA #2, the PEs 1a of all the first to fourth columns are designated to the group #1.

The PE 1a illustrated in the reference sign D2 includes a register (reg) 11, a multiplier 12, an adder 13, four FFs 14, and a selector 17. The elements illustrated by dashed lines in the PE 1a indicate elements added to the elements in the PE 6 of the related example illustrated in FIG. 1.

The register 11 stores an element of the matrix B from the signal line b. The multiplier 12 multiplies an element of the matrix A received from the signal line a and an element of the matrix B stored in the register 11. The adder 13 adds the result of the multiplication of the multiplier 12 and the matrix C from the signal line s.

In response to a sel signal input from the controller 100, the selector 17 selects an input received from the signal line a or an input received from the signal line e that inputs the matrix A into the SA #2, and outputs the selected input to the signal line a′.

In other words, the controller 100 switches the output signals from the selectors 17 in the multiple PEs 1a between the PEs 1a on the last (most downstream) stage (column) of the SA #1 and the remaining PEs 1a (i.e., the PEs 1a except for the PEs 1a on the last stage (column) of the SA #1 and the PEs 1a of the SA #2). The PEs 1a on the last stage (column) of the SA #1 are examples of first processing elements. The remaining PEs 1a are examples of second processing elements.

As indicated by the reference sign D1, into the PEs 1a of the group #1, the sel signal “0” is input, and into the PEs 1a of the group #2, the sel signal “1” is input.

This means that since sel=0 is input into the selector 17 of each PE 1a of the group #1, the selector 17 outputs the input received from the signal line a. In contrast, since sel=1 is input into the selector 17 of each PE 1a of the group #2, the selector 17 outputs the input received from the signal line e.

In the reference sign D2, the input received from the signal line b is output from signal line b′ without any modification, and the input received from the signal line e is output from signal line e′ without any modification.

The four FFs 14 are provided immediately before (upstream of) the output signal lines a′, b′, e′, and s′ and adjust the output timing of the respective output signals.

Into each PE 1a of the leftmost (most upstream) column, the matrix A to the SA #1 is input from the signal line a, and the matrix A to the SA #2 is input from the signal line e.

Each PE 1a illustrated in the reference sign D2 includes signal line a that inputs a multiplicand matrix A₁ and a signal line e that inputs a multiplicand matrix A₂.

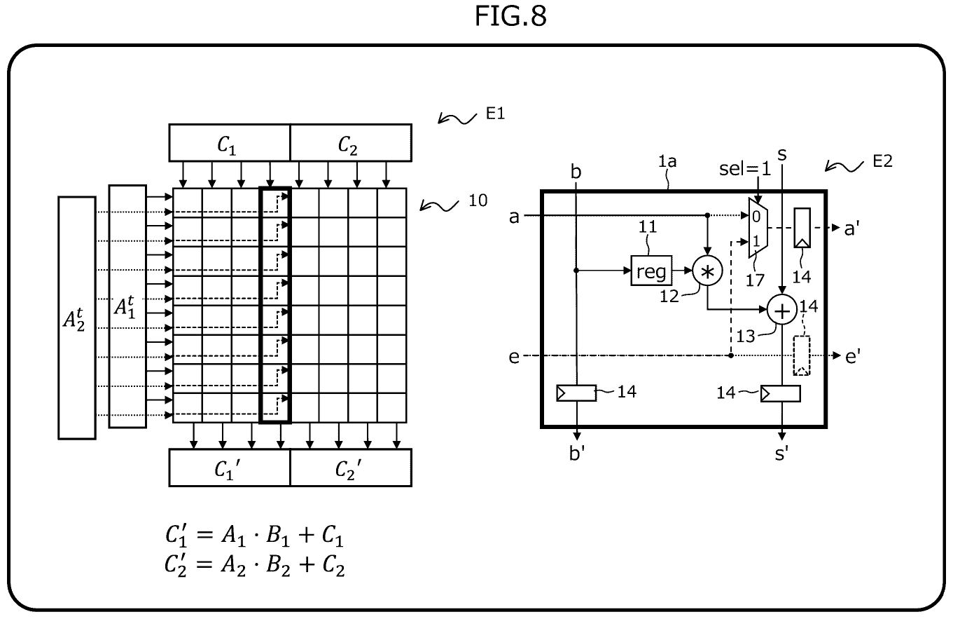

FIG. 8 is a diagram illustrating a data flow in a PE 1a on a boundary column in the SA 10 in the matrix multiply-add process of FIG. 7. In the reference sign E1 of FIG. 8, the boundary line in SA 10 is indicated by a thick frame.

In the example illustrated in FIG. 8, two matrix calculations of the half size in the column direction of the SA 10 are performed as illustrated in the following expressions.

$${C}_{1}^{′} = {A}_{1} \cdot {B}_{1} + {C}_{1}$$

$${C}_{2}^{′} = {A}_{2} \cdot {B}_{2} + {C}_{2}$$

As illustrated in the reference sign E1, into the SA 10, a matrix A₁^{t} is input into the SA #1 from the row direction and a matrix A₂^{t} is input into the SA #2 from the row direction, and also a matrix C₁ is input into the SA #1 from the column direction and a matrix C₂ is input into the SA #2 from the column direction. Then, the matrix C₁′ is output from the column direction of the SA #1, and the matrix C₂′ is output from the column direction of the SA #2. The matrix B is input through the signal line(s) b beforehand and held in the register(s) 11.

As illustrated in the reference sign E2, since sel=1 is input into the selector 17 of each PE 1a of the boundary column, the selector 17 outputs the input received from the signal line e.

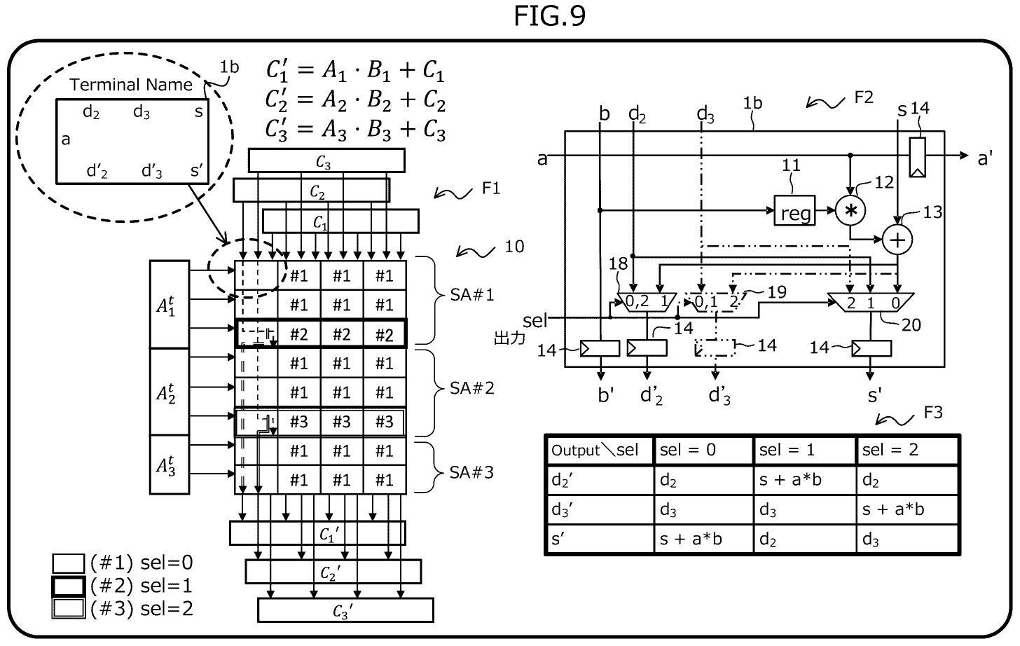

FIG. 9 is a diagram illustrating a matrix multiply-add process when a SA 10 is partitioned to three partitions in a vertical direction according to the embodiment.

In the reference sign F1 of FIG. 9, the boundary rows in the SA 10 are indicated by a thick frame and a double frame.

In the example illustrated in FIG. 9, three matrix calculations are performed, as indicated by the following expressions.

$${C}_{1}^{′} = {A}_{1} \cdot {B}_{1} + {C}_{1}$$

$${C}_{2}^{′} = {A}_{2} \cdot {B}_{2} + {C}_{2}$$

$${C}_{3}^{′} = {A}_{3} \cdot {B}_{3} + {C}_{3}$$

As illustrated in the reference sign F1, into the SA 10, a matrix A₁^{t} is input into the SA #1 from the row direction, a matrix A₂^{t} is input into the SA #2 from the row direction, a matrix A₃^{t} is input into the SA #3 from the row direction, and also a matrix C₁ is input into the SA #1 from the column direction, a matrix C₂ is input into the SA #2 from the column direction, and a matrix C₃ is input into the SA #3 from the column direction. Then, the matrix C₁′ is output from the SA #1 from the column direction, the matrix C₂′ is output from the SA #2 from the column direction, and the matrix C₃′ is output from the SA #3 from the column direction. The matrix B is input through the signal line (s) b beforehand and held in the register(s) 11.

As illustrated in the reference sign F1, in each PE 1b, the matrices A₁^{t}, A₂^{t}, A₃^{t} are input from a terminal a, the matrix C₃ is input from a terminal d₂, the matrix C₂ is input from a terminal d₃, and the matrix C₁ is input from a terminal s. The matrix C₁′ is output from a terminal d₂′, the matrix C₂′ is output from a terminal d₃′, and the matrix C₃′ is output from a terminal s′. Terminals a, d₂, d₃, s, d₂′, d₃′ and s′ illustrated in the reference sign F1 correspond to signal lines a, d₂, d₃, s, d₂′, d₃′ and s′ illustrated in the reference sign F2, respectively.

Among the PEs 1b included in the SA #1, the PEs 1b of the first to second rows are designated to the group #1, and the PEs 1b of the third row, which is the boundary row with the SA #2, are designated to the group #2. In addition, among the PEs 1b included in the SA #2, the PEs 1b of the first to second rows are designated to the group #1, and the PEs 1b of the third row, which is the boundary row with the SA #3, are designated to the group #3. On the other hand, in the SA #3, the PEs 1b of all the first to second rows are designated to the group #1.

The PE 1b illustrated in the reference sign F2 includes a register (reg) 11, a multiplier 12, an adder 13, five FFs 14 and selectors 18-20. The elements indicated by the two-dot chain lines in the PE 1b indicate elements added to the elements in the PE 1 of the SA 10 vertically partitioned into two partitions as illustrated in FIG. 3.

The register 11 stores an element of the matrix B received from the signal line b. The multiplier 12 multiplies an element of the matrix A from the signal line a and an element of the matrix B stored in the register 11. The adder 13 adds the result of the multiplication of the multiplier 12 and a partial sum from the signal line s.

In response to a sel signal, the selector 18 selects an input received from signal line d₂ or the result of the addition of the adder 13, and outputs the selected input or the selected result to the signal line d₂′. In response to a sel signal, the selector 19 selects an input received from signal line d₃ or the result of the addition of the adder 13, and outputs the selected input or the selected result to the signal line d₃′. In response to a sel signal, the selector 20 selects the input received from signal line d₂ or the input from signal line d₃ or the result of the addition of the adder 13, and outputs the selected input or the selected result to the signal line s′.

As indicated by the reference sign F1, the sel signal “0” is input into the PEs 1b of the group #1, the sel signal “1” is input into the PEs 1b of the group #2, and the sel signal “2” is input into the PEs 1b of the group #3.

This means that since sel=0 is input into the selectors 18-20 of the PEs 1b of the group #1, the selector 18 outputs the input received from the signal line d₂, the selector 19 outputs the input received from the signal line d₃, and the selector 20 outputs the result of the addition of the adder 13. In PE 1b of the group #2, since sel=1 is input into the selectors 18-20 of the PEs 1b of the group #2, the selector 19 outputs the input received from the signal line d₃, the selector 20 outputs the input received from the signal line d₂, and the selector 18 outputs the result of the addition of the adder 13. Furthermore, in PE 1b of the group #3, since sel=2 is input to selector 18-20, the selector 18 outputs the input from the signal line d₂, the selector 19 outputs the result of the addition of the adder 13, and the selector 20 outputs the input from the signal line d₃.

The five FFs 14 are provided immediately before (upstream of) the output signal lines a′, b′, d₂′, d₃′, and s′, and adjust the output timing of the respective output signals.

The reference sign F3 indicates the output values from the respective signal lines according to the sel signal. If sel=0, a value d₂ is output from the signal line d₂′, a value d₃ is output from the signal line d₃′, and a value s+a*b is output from the signal line s′. If sel=1, the value s+a*b is output from the signal line d₂′, the value d₃ is output from the signal line d₃′, and the value d₂ is output from the signal line s′. Furthermore, if sel=2, a value d₂ is output from the signal line d₂′, a value s+a*b is output from the signal line d₃′, and a value d₃ is output from the signal line s′.

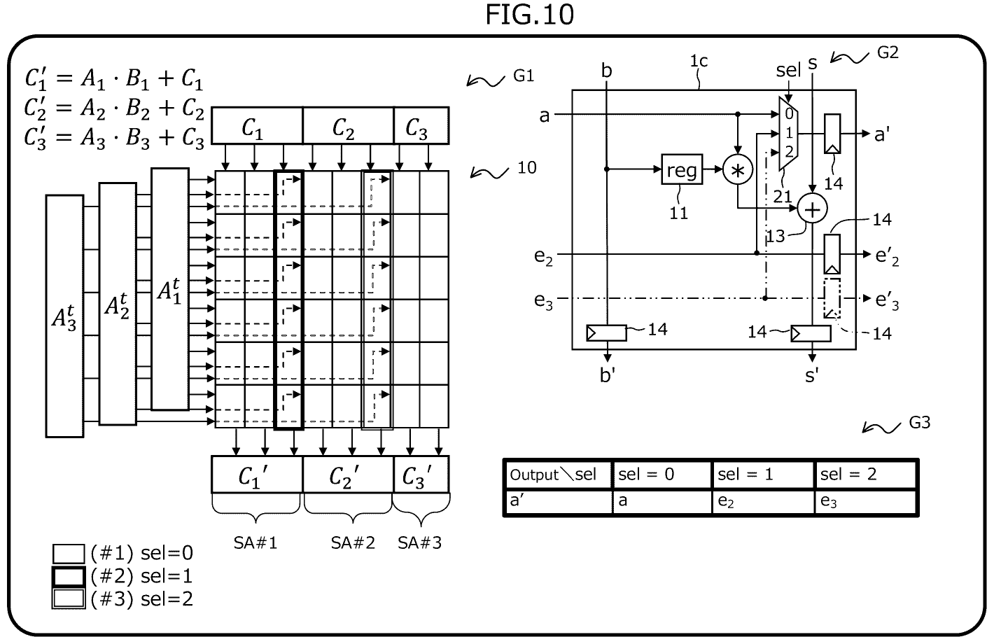

FIG. 10 is a diagram illustrating a matrix multiply-add process when a SA 10 is partitioned to three partitions in a horizontal direction according the embodiment.

In the reference sign G1 of FIG. 10, the boundary columns in the SA 10 are indicated by a thick frame and a double frame.

In the example illustrated in FIG. 10, three matrix calculations are performed, as indicated by the following expressions.

$${C}_{1}^{′} = {A}_{1} \cdot {B}_{1} + {C}_{1}$$

$${C}_{2}^{′} = {A}_{2} \cdot {B}_{2} + {C}_{2}$$

$${C}_{3}^{′} = {A}_{3} \cdot {B}_{3} + {C}_{3}$$

As illustrated in the reference sign G1, into the SA 10, a matrix A₁^{t} is input into the SA #1 from the row direction, a matrix A₂^{t} is input into the SA #2 from the row direction, a matrix A₃^{t} is input into the SA #3 from the row direction, and also a matrix C₁ is input into the SA #1 from the column direction, a matrix C₂ is input into the SA #2 from the column direction, and a matrix C₃ is input into the SA #3 from the column direction. Then, the matrix C₁′ is output from the SA #1 from the column direction, the matrix C₂′ is output from the SA #2 from the column direction, and the matrix C₃′ is output from the SA #3 from the column direction. The matrix B is input through the signal line(s) b beforehand and held in the register(s) 11.

Among the PEs 1c included in the SA #1, the PEs 1c of the first to second columns are designated to the group #1, and PEs 1c of the third column, which is the boundary column with the SA #2, are designated to the group #2. In addition, among the PEs 1c included in the SA #2, the PEs 1c of the first to second columns are designated to the group #1, and PEs 1c of the third column, which is the boundary column with the SA #3, are designated to the group #3. On the other hand, in the SA #3, the PEs 1c of all the first to second columns are designated to the group #1.

The PE 1c illustrated in the reference sign G2 includes a register (reg) 11, a multiplier 12, an adder 13, five FFs 14, and a selector 21. The elements indicated by the two-dot chain lines in the PE 1c indicate elements added to the elements in the PE 1a of the SA 10 horizontally partitioned into two partitions as illustrated in FIG. 7.

The register 11 stores an element of the matrix B from the signal line b. The multiplier 12 multiplies an element of the matrix A received from the signal line a and an element of the matrix B stored in the register 11. The adder 13 adds the result of the multiplication of the multiplier 12 and the matrix C from the signal line s.

In response to a sel signal, the selector 21 selects an input received from the signal line a, an input received from a signal line e₂, or an input received from a signal line e₃, and outputs the selected input to the signal line a′.

As indicated by the reference sign G1, the sel signal “0” is input into the PEs 1c of the group #1, the sel signal “1” is input into the PEs 1c of the group #2, and the sel signal “2” is input into the PEs 1c of the group #3.

This means that since sel=0 is input into the selector 21 of each PE 1c of the group #1, the selector 21 outputs the input received from the signal line a. Furthermore, since sel=1 is input into the selector 21 of each PE 1c of the group #2, the selector 21 outputs the input received from the signal line e₂. Moreover, since sel=2 is input into the selector 21 of each PE 1c of the group #3, the selector 21 outputs the input received from the signal line e₃.

The five FFs 14 are provided immediately before (upstream of) the output signal lines a′, b′, e₂′, e₃′, and s′, and adjust the output timing of the respective output signals.

The reference sign G3 indicates the output values from the respective signal lines according to the sel signal. If sel=0, a value a is output from the signal line a′. If sel=1, a value e₂ is output from the signal line a′. Furthermore, if sel=2, a value e₃ is output from the signal line a′.

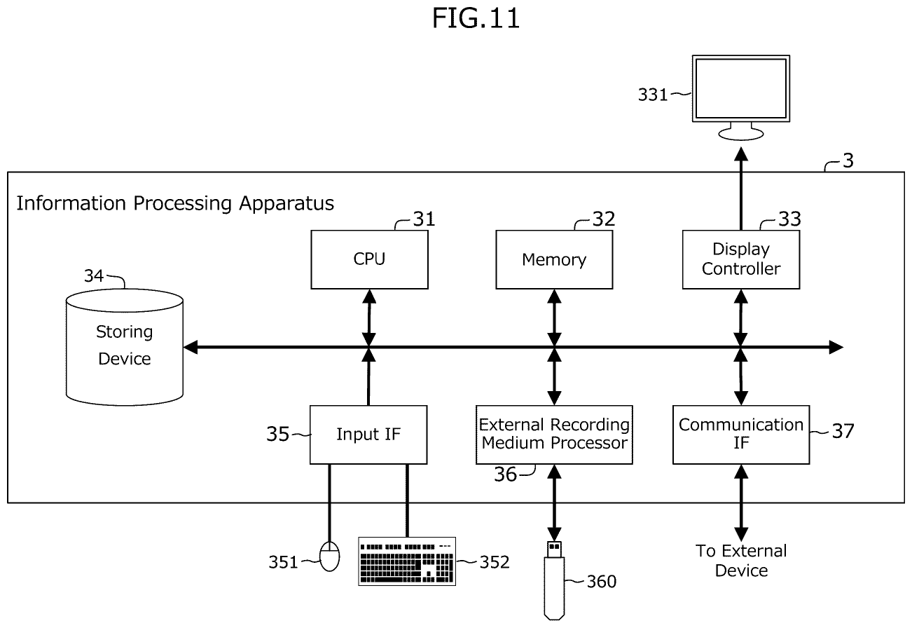

FIG. 11 is a block diagram schematically illustrating an example of a hardware configuration of the information processing apparatus 3 of the embodiment.

As illustrated in FIG. 11, the information processing apparatus 3 includes a Central Processing Unit (CPU) 31, a memory 32, a display controller 33, a storing device 34, an Input interface (IF) 35, an external recording medium processor 36, and a communication IF 37. The information processing apparatus 3 may be a server or a supercomputer.

The memory 32 is an example of a storage device, and may be exemplified by a Read Only Memory(ROM) or a Random Access Memory (RAM). In the ROM of the memory 32, a program such as Basic Input/Output System (BIOS) may be written. The software program in the memory 32 may be appropriately read and executed by the CPU 31. The RAM of the memory 32 may be used as a temporarily memory or a working memory.

The display controller 33 is connected to a display device 331 and controls the display device 331. Examples of the display device 331 are a Liquid Crystal Display, an Organic Light-Emitting Diode (OLED) display, a Cathode Ray Tube (CRT) display, and an electronic paper display. The display device 331 displays thereon various information to the operator or the like of the information processing apparatus 3, or the like. The display device 331 may be combined with an input device, and may be, for example, a touch panel.

Examples of the storing device 34 are a Solid State Drive (SSD), a Storage Class Memory (SCM), a Hard Disk Drive (HDD).

The input IF 35 may be connected with an input device such as a mouse 351 and a keyboard 352, and control the input device such as the mouse 351 and the keyboard 352. The mouse 351 and the keyboard 352 are examples of the input device and the operator or the like of the information processing apparatus 3 makes various input with these input devices.

The external recording medium processor 36 is configured such that a recording medium 360 can be mounted. The external recording medium processor 36 is configured to, under a state where the recording medium 360 is mounted thereon, be capable of reading information stored in the recording medium 360. The recording medium 360 is carriable in the illustrated example. Examples of the recording medium 360 is a non-transitory recording medium, such as a flexible disk, an optical disk, a magnetic disk, a magneto-optic disk, and a semiconductor memory.

The communication IF 37 is an interface that enables communication with an external devices.

The CPU 31 is an example of a processor and a processing device that carries out various controls and arithmetic operations. The CPU 31 functions the SA 10 and the controller 100. The CPU 31 achieves various functions by executing the OS and programs read into the memory 32. The CPU 31 may be a multi-processor including multiple CPUs or a multi-core processor including multiple CPU cores, or may have a structure including two or more multi-core processors.

The apparatus that controls the overall operation of the PE 1 is not limited to the CPU 31 and may be any one of a Micro Processing Unit (MPU), a Digital Signal Processor (DSP), an Application Specific Integrated Circuit (ASIC), a Programmable Logic Device (PLD), and a Field Programmable Gate Array (FPGA), or combinations of two or more of these ICs.

### <C> Effects

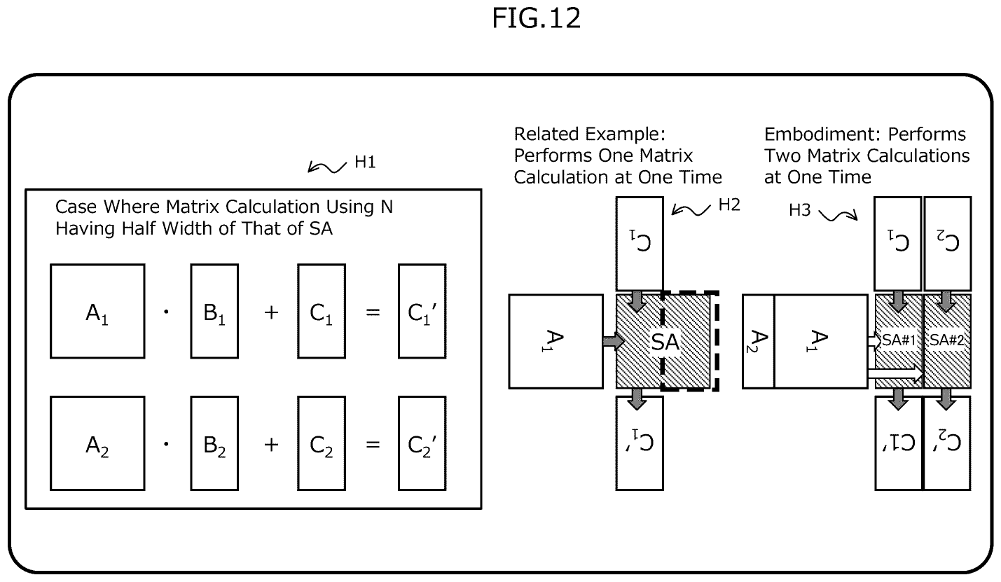

FIG. 12 is a diagram illustrating comparison between the matrix multiply-add process of the embodiment and that of the related example.

By referring to FIG. 12, description will now be made in relation to a matrix calculation of the following expressions in which a matrix has a column size N being the half the width of the SA 10 as indicated by the reference sign H1.

$${A}_{1} \cdot {B}_{1} + {C}_{1} = {C}_{1}^{′}$$

$${A}_{2} \cdot {B}_{2} + {C}_{2} = {C}_{2}^{′}$$

In the related example indicated by the reference sign H2, since one matrix arithmetic operation is performed at one time, the part enclosed by the dashed frame in the SA 10 is not used. On the other hand, in the embodiment indicated by the reference sign H3, two matrix calculations are performed at one time which makes it possible to partition the SA 10 into a SA #1 and a SA #2 and carry out the two matrix calculations in parallel with each other.

The systolic array, the information processing apparatus, and a method for arithmetic operation of the embodiment described above can bring the following effects, for example.

The SA 10 includes the SA #1 partitioned from a systolic array, the SA #2 partitioned from the systolic array and positioned downstream of the SA #1, and the controller 100. The multiple PEs 1, 1a each include the selectors 15 to 17 that selectively outputs an output signal. The controller 100 switches the output signals from the selectors 15-17 between the PEs 1, 1a on the last stage of the SA #1 and the remaining PEs 1, 1a (i.e., the PEs 1, 1a except for the PEs 1, 1a on the last stage of the SA #1 and the PEs 1, 1a of the SA #2).

This can avoid degradation of calculation performance in a matrix product arithmetic calculation of a small matrix.

In execution of the matrix operation of C₁′=A₁·B₁+C₁ and the matrix operation of C₂′=A₂·B₂+C₂ when the SA #1 and SA #2 are obtained by vertically partitioning the SA 10, each of the multiple PEs 1 includes a signal line that outputs a result C₁′ of an arithmetic operation from the input of the constant matrix C₁, and a signal line that outputs a result C₂′ of an arithmetic operation from the input of the constant matrix C₂.

This can avoid degradation of arithmetic calculation performance in a matrix product arithmetic calculation of a matrix having a small vertical size.

In execution of the matrix operation of C₁′=A₁·B₁+C₁ and the matrix operation of C₂′=A₂·B₂+C₂ when the SA #1 and SA #2 are obtained by horizontally partitioning the SA 10, each of the multiple PEs 1 includes a signal line that inputs a multiplicand matrix A₁, and a signal line that inputs a multiplicand matrix A₂.

This can avoid degradation of arithmetic calculation performance in a matrix product arithmetic operation of a matrix having a small horizontal size.

### <D> Miscellaneous

The disclosed techniques are not limited to the embodiment described above, and may be variously modified without departing from the scope of the present embodiment. The respective configurations and processes of the present embodiment can be selected, omitted, and combined according to the requirement.

The above embodiment assumes that the SA 10 is partitioned into two or three partitions, but the number of partitions is not limited to those. The matrix product operation may be performed with a SA 10 partitioned into four or more partitions. This can avoid degradation of arithmetic calculation performance in a matrix product operation by a matrix much smaller than the size of the SA 10.

In one aspect, it is possible to avoid degradation of arithmetic calculation performance in a matrix product calculation of a small matrix.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A systolic array comprising a plurality of processing elements, the systolic array comprising:
a first systolic array and a second systolic array that are obtained by partitioning the systolic array, the second systolic array being positioned downstream of the first systolic array; and
a controller, wherein
each of the plurality of processing elements comprises a selector that selectively outputs an output signal, and
the controller switches the output signals of the plurality of processing elements from the selectors between first processing elements positioned on a last stage of the first systolic array and second processing elements, the second processing elements being processing elements of the second systolic array and processing elements of the first systolic array except for the first processing elements.

2. The systolic array according to claim 1, wherein
in executing a matrix calculation of C₁′=A₁·B₁+C₁ and a matrix calculation of C₂′=A₂·B₂+C₂ when the first systolic array and the second systolic array are obtained by partitioning the systolic array in a vertical direction,
each of the plurality of processing elements comprises a signal line that outputs an arithmetic result C₁′ from an input of a constant matrix C₁ and a signal line that outputs an arithmetic result C₂′ from an input of a constant matrix C₂.

3. The systolic array according to claim 1, wherein
in executing a matrix calculation of C₁′=A₁·B₁+C₁ and a matrix calculation of C₂′=A₂·B₂+C₂ when the first systolic array and the second systolic array are obtained by partitioning the systolic array in a horizontal direction,
each of the plurality of processing elements comprises a signal line that inputs a multiplicand matrix A₁ and a signal line that inputs a multiplicand matrix A₂.

4. The systolic array according to claim 2, wherein
in executing a matrix calculation of C₁′=A₁·B₁+C₁ and a matrix calculation of C₂′=A₂·B₂+C₂ when the first systolic array and the second systolic array are obtained by partitioning the systolic array in a horizontal direction,
each of the plurality of processing elements comprises a signal line that inputs a multiplicand matrix A₁ and a signal line that inputs a multiplicand matrix A₂.

5. An information processing apparatus comprising a systolic array comprising a plurality of processing elements, the information processing apparatus comprising:
a first systolic array and a second systolic array that are obtained by partitioning the systolic array, the second systolic array being positioned downstream of the first systolic array; and
a controller, wherein
each of the plurality of processing elements comprises a selector that selectively outputs an output signal, and
the controller switches the output signals of the plurality of processing elements from the selectors between first processing elements positioned on a last stage of the first systolic array and second processing elements, the second processing elements being processing elements of the second systolic array and processing elements of the first systolic array except for the first processing elements.

6. The information processing apparatus according to claim 5, wherein
in executing a matrix calculation of C₁′=A₁·B₁+C₁ and a matrix calculation of C₂′=A₂·B₂+C₂ when the first systolic array and the second systolic array are obtained by partitioning the systolic array in a vertical direction,
each of the plurality of processing elements comprises a signal line that outputs an arithmetic result C₁′ from an input of a constant matrix C₁ and a signal line that outputs an arithmetic result C₂′ from an input of a constant matrix C₂.

7. The information processing apparatus according to claim 5, wherein
in executing a matrix calculation of C₁′=A₁·B₁+C₁ and a matrix calculation of C₂′=A₂·B₂+C₂ when the first systolic array and the second systolic array are obtained by partitioning the systolic array in a horizontal direction,
each of the plurality of processing elements comprises a signal line that inputs a multiplicand matrix A₁ and a signal line that inputs a multiplicand matrix A₂.

8. The information processing apparatus according to claim 6, wherein
in executing a matrix calculation of C₁′=A₁·B₁+C₁ and a matrix calculation of C₂′=A₂·B₂+C₂ when the first systolic array and the second systolic array are obtained by partitioning the systolic array in a horizontal direction,
each of the plurality of processing elements comprises a signal line that inputs a multiplicand matrix A₁ and a signal line that inputs a multiplicand matrix A₂.

9. A computer-implemented method of executing an arithmetic operation in a systolic array comprising a plurality of processing elements, the systolic array comprising a first systolic array and a second systolic array that are obtained by partitioning the systolic array, the second systolic array being positioned downstream of the first systolic array, each of the plurality of processing elements comprising a selector that selectively outputs an output signal, the method comprising
switching the output signals of the plurality of processing elements from the selectors between first processing elements positioned on a last stage of the first systolic array and second processing elements, the second processing elements being processing elements of the second systolic array and processing elements of the first systolic array except for the first processing elements.

10. The computer-implemented method according to claim 9 comprising
when the first systolic array and the second systolic array are obtained by partitioning the systolic array in a vertical direction,
executing a matrix calculation of C₁′=A₁·B₁+C₁ and a matrix calculation of C₂′=A₂·B₂+C₂ by using a signal line that outputs an arithmetic result C₁′ from an input of a constant matrix C₁ and a signal line that outputs an arithmetic result C₂′ from an input of a constant matrix C₂, the signal lines being included in each of the plurality of processing elements.

11. The computer-implemented method according to claim 9 comprising
when the first systolic array and the second systolic array are obtained by partitioning the systolic array in a horizontal direction,
executing a matrix calculation of C₁′=A₁·B₁+C₁ and a matrix calculation of C₂′=A₂·B₂+C₂ by using a signal line that inputs a multiplicand matrix A₁ and a signal line that inputs a multiplicand matrix A₂, the signal lines being included in each of the plurality of processing elements.

12. The computer-implemented method according to claim 10, wherein
when the first systolic array and the second systolic array are obtained by partitioning the systolic array in a horizontal direction,
executing a matrix calculation of C₁′=A₁·B₁+C₁ and a matrix calculation of C₂′=A₂·B₂+C₂ by using a signal line that inputs a multiplicand matrix A₁ and a signal line that inputs a multiplicand matrix A₂, the signal lines being included in each of the plurality of processing elements.
